(19) United States
(12) Patent Application Publication
(10) Pub. No.: US 2007/0048575 A1
(43) Pub. Date: Mar. 1, 2007

(54) Electrochemical cells containing spun mercury-amalgamated zinc particles having improved physical characteristics

(75) Inventors: Rodney S. McKenzie, Madison, WI (US); Paul Pratt, Lone Rock, WI (US); Stephanie Curtis, Pardeeville, WI (US); Jeffrey A. Poirier, Madison, WI (US)

Correspondence Address: SENNIGER POWERS, ONE METROPOLITAN SQUARE, 16TH FLOOR, ST LOUIS, MO, 63102, US

(73) Assignee: Rovcal, Inc., Madison, WI (US)

(21) Appl. No.: 11/215,219

(22) Filed: Aug. 30, 2005

(51) Int. Cl. H01M 12/06; H01M 4/42

(52) U.S. Cl. 429/27; 429/230; 429/29

(57) ABSTRACT

A metal-air electrochemical cell that includes spun mercury-amalgamated zinc powder particles is disclosed. The mercury-amalgamated zinc powder particles have advantageous physical properties that improve the performance characteristics of the cell including increasing the rate capability while decreasing the failure rate of the cell from buildup of hydrogen gas in the cell.

### FIELD OF THE INVENTION

The present invention generally relates to alkaline electrochemical cells. More specifically, the present invention relates to alkaline electrochemical cells, such as metal-air electrochemical cells, which comprise a gelled anode comprising a spun mercury-amalgamated zinc powder having advantageous physical characteristics.

### BACKGROUND OF THE INVENTION

Electrochemical cells, commonly known as “batteries,” are used to power a wide variety of devices used in everyday life. For example, devices such as radios, toys, cameras, flashlights, and hearing aids all ordinarily rely on one or more electrochemical cells to operate.

Electrochemical cells, such as metal-air electrochemical cells commonly utilized in hearing aids, produce electricity by electrochemically coupling in a cell a reactive gelled metallic anode, such as a zinc-containing gelled anode, to an air cathode through a suitable electrolyte, such as potassium hydroxide. As is known in the art, an air cathode is generally a sheet-like member having opposite surfaces that are exposed to the atmosphere and to an aqueous electrolyte of the cell, respectively. During operation of the cell, oxygen from the air dissociates at the cathode while metal (generally zinc) of the anode oxidizes, thereby providing a usable electric current flow through the external circuit between the anode and the cathode.

Many metallic-based gelled anodes are thermodynamically unstable in an aqueous neutral or alkaline electrolyte and can react with the electrolyte to corrode or oxidize the metal and generate hydrogen gas. This corrosive self-discharge side reaction can reduce both service and shelf life of electrochemical cells that use zinc as the anodic fuel. During discharge, electrochemical oxidation occurs at the anode, and metallic zinc is oxidized to zinc hydroxide, zincate ions, or zinc oxide. Under conditions such as high discharge rates or low electrolyte concentration, where the product of discharge is too densely attached to the surface, passivation of the zinc can occur. The presence of a solid phase zinc oxide or hydroxide film can interfere with the discharge efficiency of the zinc-based anode.

To combat these problems, mercury has conventionally been added to the zinc-based anode to improve the corrosion resistance and discharge behavior of the anode. Additionally, technologies aimed at substituting other components for mercury have been developed. With these technologies, small amounts of lead, calcium, indium, bismuth, and combinations thereof have been combined with zinc to provide a zinc alloy. Unfortunately, it has been shown that many of these alternative materials (i.e., mercury-free) tend to exhibit a drop in both operating voltage and service life as compared to zinc anodes containing a mercury additive. These limitations may be especially noticeable when the cell is discharged at a high rate. This is most likely due to either zinc particle surface passivation, caused by zinc oxide forming at the zinc surface, and/or anode polarization. These may both be caused by the lack of a sufficient quantity of hydroxyl ions in the anode, and/or a sufficiently even distribution of hydroxyl ions.

As such, a need still exists for electrochemical cells that provide acceptable performance while reducing the potential negative impact of the mercury in mercury-amalgamated zinc air cells.

### SUMMARY OF THE INVENTION

Among the various aspects of the present invention is an electrochemical cell such as a metal-air electrochemical cell that includes a spun mercury-amalgamated zinc powder having advantageous physical properties. These physical properties include an apparent density of at least about 3 g/cm³, a powder flow rate where 50 grams of the powder flows through a Hall Flow apparatus in less than about 40 seconds and a particle size range from about 77 microns to about 300 microns.

As such, the present invention is directed to a metal-air electrochemical cell comprising an anode and a cathode. The anode comprises an electrolyte and spun mercury-amalgamated zinc powder particles, wherein at least 50% (by weight) of the spun mercury-amalgamated zinc powder particles have an apparent density from about 2.8 g/cm³ to about 3.2 g/cm³.

The present invention is further directed to a metal-air electrochemical cell comprising an electrolyte and spun mercury-amalgamated zinc powder particles, wherein about 50 grams of the spun mercury-amalgamated zinc powder particles have a flowability as defined herein of less than about 40 seconds.

The present invention is further directed to an alkaline electrochemical cell comprising an anode and a cathode. The anode comprises an electrolyte and spun mercury-amalgamated zinc powder particles, wherein at least 50% (by weight) of the spun mercury-amalgamated zinc powder particles have an apparent density from about 2.8 g/cm³ to about 3.2 g/cm³.

The present invention is further directed to a metal-air electrochemical cell comprising an anode and a cathode. The anode comprises an anode active material and electrolyte. The anode active material comprises about 100% (by weight) spun mercury-amalgamated zinc powder particles, and at least 50% (by weight) of the spun mercury-amalgamated zinc powder particles have an apparent density from about 2.8 g/cm³ to about 3.2 g/cm³.

Other objects and features will be in part apparent and in part pointed out hereinafter.

### BRIEF DESCRIPTION OF THE DRAWINGS

FIG. 1 is a schematic sectional side elevational view of a metal-air button cell constructed in accordance with one embodiment of the present invention.

### DETAILED DESCRIPTION OF THE INVENTION

In accordance with the present invention, a metal-air electrochemical cell having a gelled anode comprising a spun mercury-amalgamated zinc powder is disclosed. The metal-air cells described herein possess advantageous discharge performance while substantially suppressing the production of hydrogen gas within the cell. The spun mercury-amalgamated zinc powder has the advantageous physical properties of an apparent density of at least about 3 g/cm³, a powder flow rate where 50 grams of the powder flows through a Hall Flow apparatus as described herein in less than about 40 seconds and a particle size range from about 77 microns to about 300 microns.

There are many factors that affect the performance characteristics of the metal-air electrochemical cells of the present invention. One factor that affects the rate capability of metal-air cells is the physical characteristics of the mercury-amalgamated zinc powder included in the anode. In this context, the rate capability of the electrochemical cell is affected by the surface area and surface condition of the mercury-amalgamated zinc particles. For example, as the surface area of the particles increases, generally, the rate capability increases. With respect to the surface condition of the particles, as the oxide layer on the particle surface decreases, the rate capability increases, as a greater amount of zinc is available for reaction. Further, the inter-particulate contact of the particles affects the rate capability in that sustained contact between particles increases the rate capability. Finally, the morphology of the zinc oxide product formed upon discharge affects the rate capability in that more dense zinc oxides take up less electrolyte and show reduced separation of the remaining zinc particles as compared to less dense zinc oxide products, thus allowing the unreacted mercury-amalgamated zinc particles to remain in closer contact with each other.

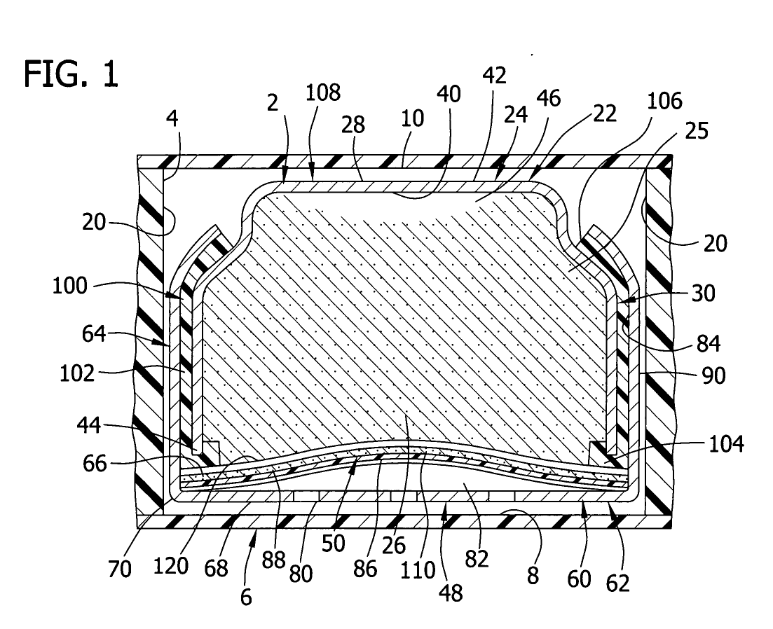

The present invention is directed to an electrochemical cell having, for example, the configuration represented in FIG. 1 and described in more detail below.

Referring now to FIG. 1, a metal-air cell, and in particular a button cell 2, is deposited in a battery cavity 4 of an appliance 6. The cavity 4 is generally bounded by a bottom wall 8, a top wall 10, and side walls 20.

The negative electrode of the cell 2, commonly known as the anode 22, includes an anode can 24 defining an anode/electrolyte chamber 25, which contains a gelled anode 26 comprising an anode active material and other additional additives, and an alkaline electrolyte comprising an alkaline electrolyte solution and other additional additives, each of which is discussed in further detail below. Preferably, the anode of the present invention consists of a spun mercury-amalgamated zinc paste anode active material, and may be positioned in the manner described in, for example, U.S. Pat. No. 4,957,826, which is hereby incorporated by reference as if set forth in its entirety herein.

The anode can 24 has a top wall 28 and an annular downwardly-depending side wall 30. Top wall 28 and side wall 30 have, in combination, an inner surface 40 and an outer surface 42. Side wall 30 terminates in an annular can foot 44, and defines a cavity 46 within the anode can 24, which contains the gelled anode 26.

The positive electrode of the cell 10, commonly known as the cathode 48, includes a cathode assembly 50 contained within a cathode can 60. Cathode can 60 has a bottom 62 and an annular upstanding side wall 64. Bottom 62 has a generally flat inner surface 66, a generally flat outer surface 68, and an outer perimeter 70 defined on the flat outer surface 68. Suitable air cathodes for use in the present invention are described in U.S. Pat. Nos. 4,354,958; 4,518,705; 4,615,954; 4,927,514; and 4,444,852, each of which is hereby incorporated by reference as if set forth in its entirety, and mixtures of any of the foregoing. A plurality of air ports 80 extend through the bottom 62 of the cathode can 60 to provide avenues for air to flow into the cathode 48. An air reservoir 82 spaces the cathode assembly 50 from the bottom 62 and the corresponding air ports 80. A porous air diffusion layer 86 fills the air reservoir 82, and presents an outer reaction surface 90. It should be appreciated by those of skill in the art that an air mover, not shown, could additionally be installed to assist in air circulation.

The cathode assembly 50 includes an active layer 110 that is interposed between a separator 120 and the air diffusion layer 86. Active layer 110 reduces the oxygen from the air, consuming the electrons produced by the reaction at the anode 22. Separator 120 has the primary function of preventing anodic zinc particles from coming into physical contact with the elements of the cathode assembly 50. Separator 120, however, does permit passage of hydroxyl ions and water therethrough between the anode 22 and the cathode assembly 50. The separator 120 is preferably a microporous membrane, typically polypropylene. Other suitable separator materials are described in U.S. patent application Ser. No. 10/914,934, the contents of which is hereby incorporated by reference as if set forth in its entirety.

The anode 22 is electrically insulated from the cathode 48, via the seal 100, that includes an annular side wall 102 disposed between the upstanding side wall 64 of the cathode can 60 and the downwardly-depending side wall 30 of the anode can 24. A seal foot 104 is disposed generally between the can foot 44 of the anode can 24 and the cathode assembly 50. A seal top 106 is positioned at the locus where the side wall 102 of the seal 100 extends from between the side walls 30 and 64 adjacent to the top of the cell 10.

Generally, the seal 100 may be of single-piece construction. For example, the seal 100 may be molded of nylon 6,6 which has been found to be inert to the electrolyte (e.g., potassium hydroxide) contained in the anode 22, and yet also sufficiently deformable upon compression to function as a seal against the side wall 64 of the cathode can 60, as well as other components. It is contemplated that the seal 100 may alternatively be formed of other suitable materials, including without limitation polyolefin, polysulfone, polypropylene, filled polypropylene (e.g., talc-filled polypropylene), sulfonated polyethylene, polystyrene, impact-modified polystyrene, glass filled nylon, ethylene-tetrafluoroethylene copolymer, high density polypropylene and other plastic materials. One particular example of a suitable glass filled nylon material for use in forming the sealing assembly is disclosed in co-assigned U.S. patent application Ser. No. 10/914,934, the disclosure of which is incorporated herein by reference to the extent that it is consistent.

The outer surface 108 of the cell 2 is thus defined by portions of the outer surface 42 of the top of the anode can 24, outer surface 90 of the side wall 64 of the cathode can 60, outer surface 68 of the bottom 62 of the cathode can 60, and the top 106 of seal 100.

The following sections describe an anode fabrication process, an electrolyte fabrication process and formation of a gelled anode. These anode and electrolyte components are incorporated into a metal-air cell as described above to form some of the various embodiments of the metal-air cell of the present invention.

The Electrolyte Fabrication Process

The electrolyte fabrication process typically involves forming the electrolyte solution comprising water, an alkaline solution, a suspending agent, a surfactant, and zinc oxide. Suitable alkaline solutions include aqueous solutions of potassium hydroxide, sodium hydroxide, lithium hydroxide, and combinations thereof. Generally, the electrolyte solution comprises from about 20% (by weight) to about 50% (by weight), and desirably from about 25% (by weight) to about 40% (by weight) alkaline salt.

The electrolyte fabrication process also includes introducing a suspending agent into the electrolyte solution. The suspending agent is present in the electrolyte solution to suspend the surfactant present therein. The suspending agent can be any suspending agent that is known to be used in electrochemical cells. Suitable suspending agents include, for example, carboxymethylcellulose (CMC), polyacrylic acid, and sodium polyacrylate (e.g., some of those under the Carbopol® trademark, which are commercially available from Noveon, Inc., Cleveland, Ohio). The suspending agent is typically present in the electrolyte solution at a concentration of from about 0.05% (by weight) to about 1% (by weight), desirably about 0.1% (by weight) electrolyte solution. In a particularly preferred embodiment, the suspending agent is a non-crosslinked polymeric material, or a low-crosslinked polymeric material, such that in use, it is substantially non-rigid and has long-flow properties.

The electrolyte fabrication process also includes adding a surfactant to the electrolyte solution. Preferably, the surfactant is an oxazoline surfactant. Suitable oxazoline surfactants can be suspended in an anode-compatible electrolyte during the electrolyte fabrication process. U.S. Pat. No. 3,389,145, incorporated by reference herein as if set forth in its entirety, discloses structures of one suitable set of oxazolines and processes for making the same. Also suitable for use in the gelled anode of the present invention are substituted oxazoline surfactants having the structures shown in U.S. Pat. No. 3,336,145, in U.S. Pat. No. 4,536,300, in U.S. Pat. No. 5,758,374, in U.S. Pat. No. 5,407,500, and in U.S. Pat. No. 6,927,000, each of which is hereby incorporated by reference as if set forth in its entirety, and mixtures of any of the foregoing. A most preferred oxazoline surfactant, ethanol, 2,2′-[(2-heptadecyl-4(5H)-oxazolylidine) bis (methyleneoxy-2,1-ethanediyloxy)]bis, has a structure shown as Formula (I-2) in incorporated U.S. Pat. No. 5,407,500. This is a compound commercially available from Angus Chemical (Northbrook, Ill.) and sold under the trademark Alkaterge™ T-IV. Preferably, the surfactant is present at a concentration of from about 0.1% (by weight) to about 1% (by weight), and desirably about 0.2% (by weight) electrolyte solution.

The electrolyte fabrication process additionally includes adding zinc oxide to the electrolyte solution. Specifically, the zinc oxide is present in the electrolyte solution to reduce dendrite growth, which reduces the potential for internal short circuits by reducing the potential for separator puncturing. Although preferred, in any of the embodiments described herein, the zinc oxide need not be provided in the electrolyte solution, as an equilibrium quantity of zinc oxide is ultimately self-generated in situ over time by the exposure of zinc to the alkaline environment and the operating conditions inside the cell, with or without the addition of zinc oxide per se. The zinc used in forming the zinc oxide is drawn from the zinc already in the cell, and the hydroxide is drawn from the hydroxyl ions already in the cell. Where zinc oxide is added to the electrolyte solution, the zinc oxide is preferably present in an amount of from about 0.5% (by weight) to about 4% (by weight), desirably about 2% (by weight) electrolyte solution.

In an exemplary embodiment, the electrolyte solution comprises an alkaline solution comprising potassium hydroxide in water, zinc oxide, a suspending agent, and a surfactant. In a particularly preferred embodiment, the electrolyte solution comprises potassium hydroxide in water (30-50% by weight), zinc oxide, a polyacrylic acid suspending agent, and an oxazoline surfactant.

The Coated Metal Anode Fabrication Process

The coated metal anode fabrication process typically involves mixing an anode active material, which typically comprises zinc, a gelling agent, and optionally an ionically conductive clay additive. Additionally, other components such as a wetting agent, an electronically conducting polymer, or a corrosion inhibitor may optionally be added to produce the coated metal anode.

In the present invention, the anode active material utilized in the anodes includes a spun mercury-amalgamated zinc powder particle having numerous desirable characteristics described herein. Generally, the anode will comprise an anode active material including at least about 50% (by weight total anode active material) spun mercury-amalgamated zinc powder particles, more desirably at least about 75% (by weight total anode active material) spun mercury-amalgamated zinc powder particles, and even more desirably at least about 90% (by weight total anode active material) spun mercury-amalgamated zinc powder particles. In specific one embodiment, substantially all, or about 100% (by weight) of the total anode active material of the electrochemical cell is spun mercury-amalgamated zinc powder particle.

In the electrochemical cells of the present invention, the spun mercury-amalgamated zinc powder particles have an apparent density that is significantly improved as compared to that of the prior art. As discussed in more detail below, the apparent density of the zinc powder particles is an important characteristic that significantly affects the manufacturing processes. Generally, the spun mercury-amalgamated zinc powder particles have an apparent density from about 2.8 g/cm³ to about 3.2 g/cm³, suitably from about 2.9 g/cm³ to about 3.2 g/cm³, more suitably from about 3 g/cm³ to about 3.2 g/cm³, more suitably from about 3.1 g/cm³ to about 3.2 g/cm³, and still more suitably about 3.1 g/cm³. One suitable method for measuring the apparent density of the mercury amalgamated zinc powder particles is ASTM 212-99 “Standard Test Method for Apparent Density of Free-Flowing Metal Powders Using the Hall Flowmeter Funnel,” ASTM International.

Another advantageous physical property of the spun mercury-amalgamated zinc powder particles included in the anodes of the electrochemical cells of the present invention is an improved powder flow rate; that is, an improved flowing capability of the particles as compared to that of conventional zinc particles. As discussed in more detail below, the flow rate of the particles significantly impacts process conditions when the anodes are fabricated. To measure the flow rate of the spun mercury-amalgamated zinc powder particles, a Hall Flow Apparatus, as described in ASTM B213-03 “Standard Test Method for Flow Rate of Metal Powders” ASTM International, can be utilized. For the zinc powder particles described herein, about 50 grams of powder flows through a Hall Flow apparatus in less than about 40 seconds; suitably less than about 38 seconds; suitably less than about 36 seconds; suitably less than about 34 seconds; suitably less than about 32 seconds; and still more suitably less than about 30 seconds. With these flow rates, the zinc powder particles have a high rate of flow and can significantly improve the manufacturing process.

In addition to an improved apparent density and powder flow rate, the spun mercury-amalgamated zinc powder particles utilized in the anodes typically have a particle size range from about 77 to about 300 microns. Preferably, the particle size range of the powder is from about 105 to about 250 microns. Generally, the median particle size of the zinc powder is from about 105 to about 277 microns; preferably, from about 125 to about 250 microns; more preferably, from about 177 to about 225 microns.

Of the total amount of spun mercury-amalgamated zinc powder particles utilized in the anode of the electrochemical cells described herein, it is generally desirable to include at least about 50% (by weight) of spun mercury-amalgamated zinc powder particles that have an apparent density of from about 2.8 g/cm³ to about 3.2 g/cm³. At this amount, the processing conditions, as described below, for the electrochemical cell will be significantly improved. In a preferred embodiment of the present invention, at least about 75% (by weight), or even at least about 90% (by weight), of the spun mercury-amalgamated zinc powder particles utilized in the anode have an apparent density of from about 2.8 g/cm³ to about 3.2 g/cm³. In another embodiment, substantially all, or about 100% (by weight) of the spun mercury-amalgamated zinc powder particles utilized in the anode have an apparent density of from about 2.8 g/cm³ to about 3.2 g/cm³.

The spun mercury-amalgamated zinc powder particles as described herein and having the apparent density, flowability and particle size noted above are significantly improved over conventional mercury-amalgamated zinc powder particles in that they can be utilized in the manufacture of electrochemical cells more efficiently and consistently. Because the apparent density, flowability, and particle size of the zinc powder particles each affect how easily and consistently the zinc powder particles can be introduced into electrochemical cells, improving these characteristics significantly improves the manufacturing process and quality of the electrochemical cells. For example, because of the small size of button cells, which are typically used in hearing aid devices, the apparent density, flowability and particle size parameters described above advantageously allow highly consistent amounts of spun mercury-amalgamated zinc powder particles to be introduced into the button cell through a shot filling apparatus generally used in manufacturing. Typically, a constant volume of spun mercury-amalgamated zinc powder particles is delivered to the button cell, but it is consistency in the mass of the zinc particle in each cell that is desirable. Thus, controlling the physical properties as described above generally provides a highly consistent mass of zinc particles in each cell.

Additionally, the spun mercury-amalgamated zinc powder particles have the apparent improvement over conventional mercury-amalgamated zinc powder in that they allow and maintain the desirable electrical contact within the anode mass during discharge in an electrochemical cell, especially under high rate conditions where polarization in the anode can limit the discharge capacity. During discharge, particle to particle contact of the anode active material is desirable in order to ensure sufficient electrical continuity throughout the anode mass.

The spun mercury-amalgamated zinc powder described herein is produced by first atomizing molten zinc or zinc alloys by rotary atomization; second, sieving the atomized zinc or zinc alloy to separate the zinc particles of the desired size and third, amalgamating the zinc or zinc alloy particles according to the process described in U.S. Pat. No. 4,460,543 (Glaeser), the contents of which are hereby incorporated by reference as if set forth in its entirety. This sequence of steps for producing the spun mercury-amalgamated zinc powder particles is advantageous because the zinc or zinc alloy particles that are not of the desired size can be melted and atomized to prepare more particles of the desired size. Because the zinc is amalgamated after sieving, only the zinc or zinc alloy particles of the desired size are amalgamated with mercury. As a person of ordinary skill would know, this sequence of steps decreases the amount of waste mercury-amalgamated zinc particles and is thus more economically efficient and environmentally sound, while producing highly desirable amalgamated zinc.

According to the process described in U.S. Pat. No. 4,460,543 (Glaeser), zinc powder is mixed with metallic mercury in the presence of an amalgamation aid in a closed system at a partial pressure of oxygen below 100 mbar. The amalgamation aid is typically a substance that is suitable for dissolving the oxide layer of the zinc powder and preventing the formation of an oxide layer on the mercury. During the amalgamation process, the excess amalgamation aid, water vapor, and other volatile products are preferably continuously removed from the closed system. To complete the process, the partial pressure of oxygen is raised to atmospheric pressure.

During the amalgamation process, the mercury penetrates through the surface of the zinc powder and into the zinc powder particles and is distributed therein through diffusion. Smaller zinc powder particles have a correspondingly larger surface area and due to this relationship, the smaller particles produce more hydrogen gas than larger particles. As this amalgamation process starts at the particle surface and proceeds inward, the smaller particles have more mercury available for the passivation of impurities on the surface than do larger particles. As a result of the absorption of mercury by the surface of the zinc powder, there is initially a stronger coating of mercury on the surface of the zinc, i.e., where the mercury is specifically needed. This effect is increased through the use of certain amalgamation aids, such as soda lye, potash lye, hydrochloric acid, acetic acid, formic acid, carbonic acid, and ammonia. According to the amalgamation process, the zinc powder is preferably mixed with metallic mercury that has been pre-dissolved in an alloying element to further reduce gas development. These alloying elements include gold, silver, tin, cadmium, indium, and zinc. As such, the spun mercury-amalgamated zinc powder may additionally contain one or more of these alloying elements.

Further, the density of the zinc particles formed from this process can be controlled. For example, depending on the speed of the partial oxygen pressure increase at the end of the amalgamation process and the temperature of the zinc powder, the thickness of an oxide layer formed on the surface of the zinc powder can be adjusted. The density of the particles decreases with increasing thickness of the oxide layer on the zinc particle.

The zinc powder to be amalgamated in the process described above, preferably, is produced by rotary atomization (spinning disk or centrifugal atomization). In this method, generally, a spinning or atomizer disk having an inert surface is wetted with molten zinc prior to pouring molten zinc onto the zinc coated spinning disk followed by cooling the metal droplets flung off the disk to solidify them and collecting the solidified metal or metal alloy. This process is generally described in U.S. Pat. Nos. 4,415,511 and 4,456,444, herein incorporated by reference in their entirety. This process of rotary atomization has the advantage of producing more spherical zinc particles than air or steam atomization (e.g., a stream of molten metal is contacted with a high pressure stream of air or steam). Mercury-amalgamated zinc powder particles that are more spherical have better flow characteristics than particles that are less spherical. Further, zinc powder particles that will have a particle size between about 77 and 300 microns are those that are amalgamated by the process described above. Zinc powder particles of the desired size can be obtained by methods known in the art, for example, by sieving. By amalgamating only the desired size zinc particles with mercury, mercury-amalgamated zinc particles of undesirable size are not produced and thus, do not have to be disposed of.

Additionally, one or more of the above-described alloying elements may optionally be pre-dissolved in mercury. Therefore, the spun mercury-amalgamated zinc may additionally comprise one or more of the group consisting of gold, silver, tin, cadmium, indium, and zinc. Preferably, the spun mercury-amalgamated zinc comprises zinc and mercury.

Typically, the zinc powder used in the anode fabrication process is zinc powder that has been amalgamated with greater than about 0.5 parts mercury per 100 parts zinc. Desirably, the zinc powder has been amalgamated with less than about 6.0 parts mercury per 100 parts zinc. More preferably, the zinc powder has been amalgamated with from about 1 part mercury per 100 parts zinc to about 5 parts mercury per 100 parts zinc, and desirably from about 2 parts mercury per 100 parts zinc to about 4 parts mercury per 100 parts zinc. In a particularly preferred embodiment, the zinc powder has been amalgamated with about 2.4 parts mercury per 100 parts zinc.

During fabrication of the anode, a gelling agent is added, typically in dry powder form, and mixed with the spun mercury-amalgamated zinc alloy. The gelling agent acts to support the electrolyte and the anode active material (typically zinc-containing) in the gelled anode. The gelling agent also increases the distribution of the electrolyte throughout the anode, and reduces zinc self-plating, which can result in undesirable hardening of the anode.

The gelling agent present in the anode can be any gelling agent that is known to be used in electrochemical cells. Suitable gelling agents include, for example, carboxymethylcellulose (CMC), polyacrylic acid, and sodium polyacrylate (e.g., those under the Carbopol® trademark, which are commercially available from Noveon, Inc., Cleveland, Ohio). Desirably, the gelling agent is a chemical compound that has negatively charged acid groups. One particularly preferred gelling agent is Carbopol® 934, commercially available from Noveon, Inc., Cleveland, Ohio. Carbopol® 934 is a long chain polymer with acid functional groups along its backbone. The function of these acid groups on the gelling agent is to expand the polymer backbone into an entangled matrix. When these acid groups are ionized in the anode, they repel each other and the polymer matrix swells to provide a support mechanism.

Typically, the gelling agent is present in the coated zinc anode at a concentration of less than about 5.0% (by weight of anode active material comprising zinc). Preferably, the gelling agent is present in the coated zinc anode at a concentration of greater than about 0.5% (by weight of anode active material comprising zinc). More preferably, gelling agent is present in the coated zinc anode at a concentration of from about 0.1% (by weight of anode active material comprising zinc) to about 3% (by weight of anode active material comprising zinc). Most preferably, the gelling agent is present in the coated zinc anode at a concentration of from about 0.2% (by weight of anode active material comprising zinc) to about 2% (by weight of anode active material comprising zinc).

In one embodiment, added to the anode active material and gelling agent is an ionically conductive clay additive. Generally, this additive is in powder form. The ionically conductive clay additive is preferably an ionically conductive clay additive that advantageously exhibits compatibility in concentrated alkaline electrolytes, and has substantially no effect on the gassing behavior of the zinc used as the anode active material in alkaline electrochemical cells. Additionally, because the ionically conductive clay is insoluble in an aqueous alkaline or neutral electrolyte solution, dispersed clay particles throughout the anode form an ionic network that enhance the transport of hydroxyl ions through the matrix formed by the gelling agent.

Ionically conductive clay additives suitable for use in the anode are synthetically modified ionically conductive clay additives. Either natural or synthetic clays can be synthetically modified to produce ionically conductive clay additives suitable for use in the present invention. Generally, natural or synthetic clay materials suitable for synthetic modification typically have a hydroxide group, a particle charge, and at least one of aluminum, lithium, magnesium and silicon. Specifically, natural or synthetic clays such as, for example, kaolinite clays, montmorillonite clays, smectite clays, illiet clays, bentonite clays, hectorite clays, and combinations thereof may be suitable for synthetic modification and use in the anodes and electrochemical cells described herein.

Typically, the ionically conductive clay additive is present in the coated zinc anode at a concentration of from about 0.1% (by weight of anode active material comprising zinc) to about 3% (by weight of anode active material comprising zinc). Desirably, the ionically conductive clay additive is present in the coated zinc anode at a concentration of from about 0.1% (by weight of anode active material comprising zinc) to about 1% (by weight of anode active material comprising zinc); more desirably from about 0.1% (by weight of anode active material comprising zinc) to about 0.3% (by weight of anode active material comprising zinc.

Along with the gelling agent, anode active material, and ionically conductive clay additive, magnesium oxide may optionally be added in dry powder form during the coated metal anode fabrication. Magnesium oxide may be introduced into the anode to improve the self-wetting properties of the anode upon combination with electrolyte; that is, the magnesium oxide helps to soak electrolyte into the anode by wicking the electrolyte into the anode. This wicking action helps to evenly distribute the electrolyte through the anode. Typically, magnesium oxide (or other suitable wetting agents, when utilized) is present in the coated metal anode at a concentration of from about 0.1% (by weight of anode active material comprising zinc) to about 4% (by weight of anode active material comprising zinc). Desirably, magnesium oxide (or other suitable wetting agents, when utilized) is present in the coated metal anode at a concentration of about 2% (by weight of anode active material comprising zinc).

An electronic conducting polymer may also optionally be added to the coated metal anode to improve its properties. The electronic conducting polymer generally promotes increased electronic conductivity between zinc particles, and provides increased ionic conductivity in the electrolyte. The electronic conducting polymer additionally decreases the voltage dip upon initial discharge, eliminates impedance during discharge, and produces higher overall operating voltage.

Preferably, the electronic conducting polymer is polyaniline. Other electronic conducting polymers such as polypyrrole, polyacetylene, and combinations thereof may also be used. Typically, the electronic conducting polymer is added to the spun mercury-amalgamated zinc alloy at 2 parts for every 3 parts of the gelling agent.

Small amounts of one or more corrosion inhibitors may also optionally be added to the coated metal anode. The corrosion inhibitor added to the anode can be any corrosion inhibitor that is known to be used in electrochemical cells. Typically, the corrosion inhibitor is a substance known to improve the corrosion behavior of anodic zinc. Suitable corrosion inhibitors include, for example, tannic acid, aluminum, indium, lead, bismuth, and combinations thereof.

It is contemplated that the above-described coated zinc anode components used in the anode fabrication process may be combined in any particular order. For example, the ionically conductive clay additive may be added to the spun mercury-amalgamated zinc alloy prior to adding the gelling agent, and/or the magnesium oxide, and/or the electronic conducting polymer, if any. Alternatively, the ionically conductive clay additive can be added to the alkaline electrolyte at any point during the electrolyte fabrication process, described above.

In one specific embodiment, the combined dry mixture of the anode active material comprising zinc amalgamated with mercury, gelling agent, ionically conductive clay additive, and magnesium oxide, are dry blended by mixing them in an orbital mixer for about 5-10 minutes, depending on the batch size. After dry blending, the combined mixture is typically placed in a rotational tumbler, and water is sprayed on the tumbling dry mixture until a wet sand texture is achieved. The wet blended mixture is then spread out in a thin layer and allowed to dry, typically for about 24 hours. The dried material is then screened using screen sizes 18 and 30 or 40, and is then ready for mixing with the alkaline electrolyte.

The Gelled Anode Formation

Generally speaking, the gelled anode for use in the electrochemical cell as described herein is formed by combining the coated zinc anode with the surfactant-based electrolyte solution. More specifically, the coated zinc anode is dry-dispensed into the cell and then the surfactant-based alkaline electrolyte solution is dispensed onto the coated zinc anode and absorbed. Once the surfactant-based alkaline electrolyte solution has been absorbed by the coated zinc anode, the cell may be mechanically closed.

Generally, the gelled anode comprises from about 70% (by weight) to about 90% (by weight) coated zinc anode, and from about 10% (by weight) to about 30% (by weight) surfactant-based alkaline electrolyte solution.

The metal air electrochemical cells of the present invention as described herein are capable of delivering a sustained electron current sufficient to power and operate a conventional hearing aid device at a voltage above the end of life cutoff voltage of the conventional hearing aid device, which is typically greater than about 1 volt, for a commercially acceptable time period. As would be recognized by one skilled in the art based on the disclosure herein, the metal air electrochemical cells of the present invention may be of any commercially acceptable size such as, for example, 10, 312, 13, and 675.

While the present invention has been described and illustrated in combination with an zinc-air button electrochemical cell, the spun mercury-amalgamated zinc powder particles as described herein may be added to any zinc-based anode in any type of electrochemical cell including, but not limited to, zinc-manganese dioxide cells, zinc-silver oxide cells, metal-air cells including zinc in the anode, nickel-zinc cells, rechargeable zinc/alkaline/manganese dioxide (RAM) cells, zinc-bromide cells, zinc-copper oxide cells, or any other cell having a zinc-based anode. It should also be appreciated that the present invention is applicable to any suitable cylindrical metal-air cell, such as those sized and shaped, for example, as AA, AAA, AAAA, C, and D cells.

Having described the invention in detail, it will be apparent that modifications and variations are possible without departing the scope of the invention defined in the appended claims. Furthermore, it should be appreciated that all examples in the present disclosure are provided as non-limiting examples.

### EXAMPLES

The following non-limiting examples are provided to further illustrate the present invention. It should be appreciated by those of skill in the art that the techniques disclosed in the examples that follow represent approaches the inventors have found function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

### Example 1

In this Example, four different-sized zinc-air electrochemical cells were prepared with conventional alloyed zinc-containing anodes (control cells) and four different-sized zinc-air electrochemical cells are prepared with spun amalgamated zinc-containing anodes (test cells) and the performances of the cells compared. Specifically, the four sizes of zinc-air electrochemical cells produced were: 675, 13, 312, and 10.

The anodes of the control cells comprised alloyed zinc (alloyed with about 2.4% (by weight) mercury) commercially available from Umicore, Inc. (Overpelt, Belgium). This commercially available alloyed zinc had a median particle size of about 200 microns, a flowability of from about 47 to about 52 seconds and an apparent density of from about 2.8 g/cm³ to about 3.2 g/cm³. The anodes of the test cells comprised spun amalgamated zinc (2.4% by weight) as described herein having a median particle size of from about 180 microns to about 200 microns, a flowability averaging about 35 seconds and an apparent density of about 3.1 g/cm³. For both the test cell and the control cell, the anodes of the size 675 cells included about 0.82 grams of zinc-containing mercury blend and about 0.21 grams electrolyte solution. For both the test cell and the control cell, the anodes of the size 13 cells included about 0.37 grams of zinc-containing mercury blend and about 0.09 grams electrolyte solution. For both the test cell and the control cell, the anodes of the size 312 cells included about 0.22 grams of zinc-containing mercury blend and about 0.05 grams electrolyte solution. For both the test cell and the control cell, the anodes of the size 10 cells included about 0.12 grams of zinc-containing mercury blend and about 0.02 grams electrolyte solution.

Additional components of the control and test anodes are set forth in the following Table.

| | | | Potassium | | |
|---|---|---|---|---|---|
| Carbopol* | | | Hydroxide | | Magnesium |
| 934 | Carbopol 907 | Surfactant** | Electrolyte | Zinc Oxide | Oxide |
| 0.33% | 1000 ppm | 1200 ppm | 33% | 2% | 0.33% |
| (by weight | (by weight | (by weight | (by weight | (by weight | (by weight |
| zinc) | electrolyte) | electrolyte) | solution) | electrolyte) | zinc) |

*Carbopol products are commercially available from Noveon (Cleveland, Ohio)
**Surfactant used was Alkaterge TIV, commercially available from ANGUS Chemical (Buffalo Grove, Illinois)

The test and control zinc-air electrochemical cells were conventionally manufactured including the desired anode for testing. Once the zinc-air electrochemical cells were manufactured, they were stored with adhesive tabs applied for one month at room temperature (about 23° C. (75° F.)) having about 50% relative humidity prior to being analyzed according to the test procedure outlined in IEC 60086-2. The results of the tests are set forth in the Tables below.

| | | High Rate | High Rate | High Rate |
|---|---|---|---|---|
| Cell | | Test Load | Test | Capacity |
| Size | Zinc Type | (ohms) | Conditions | (mAh) |
| 675 | Alloyed | 374 | 16 hrs/day | 637 |
| 675 | Spun | 374 | 16 hrs/day | 632 |
| | Amalgamated | | | |
| 13 | Alloyed | 620 | 16 hrs/day | 277 |
| 13 | Spun | 620 | 16 hrs/day | 274 |
| | Amalgamated | | | |
| 312 | Alloyed | 1500 | 16 hrs/day | 163 |
| 312 | Spun | 1500 | 16 hrs/day | 166 |
| | Amalgamated | | | |
| 10 | Alloyed | 3000 | 16 hrs/day | 96 |
| 10 | Spun | 3000 | 16 hrs/day | 96 |
| | Amalgamated | | | |

*Refer to IEC 60086-2 for complete test details

| | | ANSI/IEC | ANSI/IEC | ANSI/IEC |
|---|---|---|---|---|
| Cell | | Test Load | Test | Capacity |
| Size | Zinc Type | (ohms) | Conditions | (mAh) |
| 675 | Alloyed | 620 | 12 hrs/day | 644 |
| 675 | Spun | 620 | 12 hrs/day | 642 |
| | Amalgamated | | | |
| 13 | Alloyed | 1500 | 12 hrs/day | 279 |
| 13 | Spun | 1500 | 12 hrs/day | 285 |
| | Amalgamated | | | |
| 312 | Alloyed | 1500 | 12 hrs/day | 162 |
| 312 | Spun | 1500 | 12 hrs/day | 165 |
| | Amalgamated | | | |
| 10 | Alloyed | 3000 | 12 hrs/day | 90 |
| 10 | Spun | 3000 | 12 hrs/day | 95 |
| | Amalgamated | | | |

*Refer to IEC 60086-2 for complete test details

As shown in the data of the tables above, in all sizes of cells analyzed, the zinc-air electrochemical cells prepared with spun amalgamated zinc-containing anodes preformed as well as, or better, than the zinc-air electrochemical cells prepared with conventional alloyed zinc-containing anodes.

What is claimed is:

1. A metal-air electrochemical cell comprising an anode and a cathode, wherein the anode comprises an electrolyte and spun mercury-amalgamated zinc powder particles, wherein at least 50% (by weight) of the spun mercury-amalgamated zinc powder particles have an apparent density from about 2.8 g/cm³ to about 3.2 g/cm³.

2. The metal-air electrochemical cell of claim 1 wherein at least about 90% (by weight) of the spun mercury-amalgamated zinc powder particles have an apparent density from about 2.9 g/cm³ to about 3.2 g/cm³.

3. The metal-air electrochemical cell of claim 1 wherein the spun mercury-amalgamated zinc powder particles have an apparent density from about 3 g/cm³ to about 3.2 g/cm³.

4. The metal-air electrochemical cell of claim 1 wherein the spun mercury-amalgamated zinc powder particles have an apparent density from about 3.1 g/cm³ to about 3.2 g/cm³.

5. The metal-air electrochemical cell of claim 1 wherein about 50 grams of the spun mercury-amalgamated zinc powder particles have a flowability as defined herein of less than about 40 seconds.

6. The metal-air electrochemical cell of claim 5 wherein about 50 grams of the spun mercury-amalgamated zinc powder particles have a flowability as defined herein of less than about 38 seconds.

7. The metal-air electrochemical cell of claim 5 wherein about 50 grams of the spun mercury-amalgamated zinc powder particles have a flowability as defined herein of less than about 36 seconds.

8. The metal-air electrochemical cell of claim 5 wherein about 50 grams of the spun mercury-amalgamated zinc powder particles have a flowability as defined herein of less than about 34 seconds.

9. The metal-air electrochemical cell of claim 1 wherein the spun mercury-amalgamated zinc powder particles have a particle size from about 77 microns to about 300 microns.

10. The metal-air electrochemical cell of claim 1 wherein the electrolyte is selected from the group consisting of potassium hydroxide, sodium hydroxide, lithium hydroxide, and combinations thereof.

11. A metal-air electrochemical cell comprising an electrolyte and spun mercury-amalgamated zinc powder particles, wherein about 50 grams of the spun mercury-amalgamated zinc powder particles have a flowability as defined herein of less than about 40 seconds.

12. The metal-air electrochemical cell of claim 11 wherein about 50 grams of the spun mercury-amalgamated zinc powder particles have a flowability as defined herein of less than about 38 seconds.

13. The metal-air electrochemical cell of claim 11 wherein about 50 grams of the spun mercury-amalgamated zinc powder particles have a flowability as defined herein of less than about 36 seconds.

14. The metal-air electrochemical cell of claim 11 wherein about 50 grams of the spun mercury-amalgamated zinc powder particles have a flowability as defined herein of less than about 34 seconds.

15. The metal-air electrochemical cell of claim 11 wherein the spun mercury-amalgamated zinc powder particles have a particle size from about 77 microns to about 300 microns.

16. The metal-air electrochemical cell of claim 11 wherein the electrolyte is selected from the group consisting of potassium hydroxide, sodium hydroxide, lithium hydroxide, and combinations thereof.

17. An alkaline electrochemical cell comprising an anode and a cathode, wherein the anode comprises an electrolyte and spun mercury-amalgamated zinc powder particles, wherein at least 50% (by weight) of the spun mercury-amalgamated zinc powder particles have an apparent density from about 2.8 g/cm³ to about 3.2 g/cm³.

18. The alkaline electrochemical cell of claim 17 wherein at least about 90% (by weight) of the spun mercury-amalgamated zinc powder particles have an apparent density from about 2.9 g/cm³ to about 3.2 g/cm³.

19. The alkaline electrochemical cell of claim 17 wherein the spun mercury-amalgamated zinc powder particles have an apparent density from about 3 g/cm³ to about 3.2 g/cm³.

20. The alkaline electrochemical cell of claim 17 wherein the spun mercury-amalgamated zinc powder particles have an apparent density from about 3.1 g/cm³ to about 3.2 g/cm³.

21. The alkaline electrochemical cell of claim 17 wherein about 50 grams of the spun mercury-amalgamated zinc powder particles have a flowability as defined herein of less than about 40 seconds.

22. The alkaline electrochemical cell of claim 21 wherein about 50 grams of the spun mercury-amalgamated zinc powder particles have a flowability as defined herein of less than about 38 seconds.

23. The alkaline electrochemical cell of claim 21 wherein about 50 grams of the spun mercury-amalgamated zinc powder particles have a flowability as defined herein of less than about 36 seconds.

24. The alkaline electrochemical cell of claim 21 wherein about 50 grams of the spun mercury-amalgamated zinc powder particles have a flowability as defined herein of less than about 34 seconds.

25. The alkaline electrochemical cell of claim 17 wherein the spun mercury-amalgamated zinc powder particles have a particle size from about 77 microns to about 300 microns.

26. The alkaline electrochemical cell of claim 17 wherein the electrolyte is selected from the group consisting of potassium hydroxide, sodium hydroxide, lithium hydroxide, and combinations thereof.

27. A metal-air electrochemical cell comprising an anode and a cathode, wherein the anode comprises an anode active material and electrolyte, wherein the anode active material comprises about 100% (by weight) spun mercury-amalgamated zinc powder particles, and wherein at least 50% (by weight) of the spun mercury-amalgamated zinc powder particles have an apparent density from about 2.8 g/cm³ to about 3.2 g/cm³.

28. The metal-air electrochemical cell of claim 27 wherein at least about 90% (by weight) of the spun mercury-amalgamated zinc powder particles have an apparent density from a bout 2.9 g/cm³ to about 3.2 g/cm³.

29. The metal-air electrochemical cell of claim 27 wherein the spun mercury-amalgamated zinc powder particles have an apparent density from about 3 g/cm³ to about 3.2 g/cm³.

30. The metal-air electrochemical cell of claim 27 wherein the spun mercury-amalgamated zinc powder particles have an apparent density from about 3.1 g/cm³ to about 3.2 g/cm³.

31. The metal-air electrochemical cell of claim 27 wherein about 50 grams of the spun mercury-amalgamated zinc powder particles have a flowability as defined herein of less than about 40 seconds.

32. The metal-air electrochemical cell of claim 31 wherein about 50 grams of the spun mercury-amalgamated zinc powder particles have a flowability as defined herein of less than about 38 seconds.

33. The metal-air electrochemical cell of claim 31 wherein about 50 grams of the spun mercury-amalgamated zinc powder particles have a flowability as defined herein of less than about 36 seconds.

34. The metal-air electrochemical cell of claim 31 wherein about 50 grams of the spun mercury-amalgamated zinc powder particles have a flowability as defined herein of less than about 34 seconds.

35. The metal-air electrochemical cell of claim 27 wherein the spun mercury-amalgamated zinc powder particles have a particle size from about 77 microns to about 300 microns.

36. The metal-air electrochemical cell of claim 27 wherein the electrolyte is selected from the group consisting of potassium hydroxide, sodium hydroxide, lithium hydroxide, and combinations thereof.
